(19) United States
(12) Patent Application Publication
(10) Pub. No.: US 2026/0183942 A1
(43) Pub. Date: Jul. 2, 2026

(54) REAL-TIME CONTROL METHODS AND SYSTEMS FOR ROBOT MANIPULATION ACTIONS BASED ON COLLABORATION BETWEEN LARGE MODELS AND SMALL MODELS

(71) Applicant: TONGJI UNIVERSITY, Shanghai (CN)

(72) Inventors: Bin HE, Shanghai (CN); Yanmin ZHOU, Shanghai (CN); Wei WANG, Shaoyang (CN); Yijie LUO, Huzhou (CN); Zhipeng WANG, Shanghai (CN); Zhongpan ZHU, Shanghai (CN)

(73) Assignee: TONGJI UNIVERSITY, Shanghai (CN)

(21) Appl. No.: 19/396,560

(22) Filed: Nov. 21, 2025

(30) Foreign Application Priority Data
Dec. 31, 2024 (CN) 202411977111.8

(51) Int. Cl. B25J 9/16; B25J 13/08

(52) U.S. Cl. CPC B25J 9/163; B25J 9/161; B25J 13/08

(57) ABSTRACT

Provided is a real-time control method for robot manipulation actions based on collaboration between a large model and a small model. The method includes combining environmental data with instruction text data to form multi-modal data, and performing preprocessing on the multi-modal data to obtain preprocessed multi-modal data; performing data encoding on the preprocessed multi-modal data to obtain a feature vector; aligning the preprocessed multi-modal data using cross-modal token alignment technology to obtain a feature representation; training a neural network model using the feature vector and the feature representation to obtain a trained large model; performing a pruning operation, a distillation operation, and a quantization operation on the trained large model to generate a small model; deploying the small model to an edge computing device to obtain robot action planning; and performing real-time control of robot manipulation actions using robot action planning and feedback signals from a plurality of sensors.

### CROSS-REFERENCE TO RELATED APPLICATIONS

This application claims priority to Chinese Patent Application No. 202411977111.8, filed on Dec. 31, 2024, the contents of which are hereby incorporated by reference.

### TECHNICAL FIELD

The present disclosure generally relates to a field of robot control technology, and in particular to a real-time control method and system for robot manipulation actions based on collaboration between a large model and a small model.

### BACKGROUND

With the rapid development of artificial intelligence technology, robot technology has been widely applied in fields such as manufacturing, services, healthcare, and logistics. Especially for robot manipulation and grasping tasks in complex environments, as the diversity and complexity of tasks increase, how robots can complete tasks quickly and accurately has become an important research direction.

Currently, success of robot manipulation and grasping tasks often depends on its perception capability and control strategy. Traditional robot grasping ways mainly rely on single-sensor data, such as a visual sensor or a tactile sensor, making it difficult to effectively handle complex environmental changes and various interference factors. Therefore, these ways have certain limitations in practical applications.

To improve grasping accuracy and efficiency of a robot in complex environments, researchers have proposed ways that fuse a plurality of perception information. A visual sensor can provide information such as object position, shape, and color, but it is highly sensitive to changes in ambient lighting and object surface texture. A tactile sensor can perceive force feedback in real time during grasping. However, in complex manipulation, relying solely on force perception cannot effectively cope with changes in object characteristics such as shape and stiffness.

Furthermore, with the advancement of deep learning technology, large language models have achieved significant results in fields such as image recognition, speech processing, and natural language processing. Through learning from massive data, a large model can acquire a powerful understanding capability for complex tasks. However, in practical applications, a large model has disadvantages such as high computational resource consumption and slow inference speed, making it difficult to meet real-time and edge computing requirements.

Currently, robot operating systems based on edge computing are gradually being applied. By deploying models to edge devices, it can achieve fast real-time inference and response. However, challenges remain in aspects such as data processing, computational resources, and real-time performance.

The present disclosure provides a real-time control method for robot manipulation actions based on collaboration between a large model and a small model. Through deep fusion of vision and tactile sensing, combined with collaborative work of the large model and the small model, it breaks through limitations of traditional robot manipulation methods are overcome and provides an innovative solution for robot manipulation tasks in complex environments.

### SUMMARY

One or more embodiments of the present disclosure provide a real-time control method for robot manipulation actions based on collaboration between a large model and a small model. The method comprises: collecting environmental data using a plurality of sensors, combining the environmental data with instruction text data to form multi-modal data, and performing preprocessing on the multi-modal data to obtain preprocessed multi-modal data, performing data encoding on the preprocessed multi-modal data to obtain a feature vector; aligning the preprocessed multi-modal data using cross-modal token alignment technology to obtain a feature representation; training a neural network model using the feature vector and the feature representation to obtain a trained large model; performing a pruning operation, a distillation operation, and a quantization operation on the trained large model to generate a small model; deploying the small model to an edge computing device, wherein the edge computing device acquires text data of a current instruction in real time and performs inference on the text data on the text data to generate robot action planning; and performing real-time control of the robot manipulation actions using the robot action planning and feedback signals from the plurality of sensors.

One or more embodiments of the present disclosure provide a real-time control system for robot manipulation actions based on collaboration between a large model and a small model. The system operates by applying the real-time control method for robot manipulation actions based on collaboration between a large model and a small model. The system comprises a data acquisition and preprocessing module, a data encoding and alignment module, a model training and optimization module, and a model deployment and control module; wherein the data acquisition and preprocessing module is configured to collect the environmental data using the plurality of sensors, combine the environmental data with the instruction text data to form the multi-modal data; and perform the preprocessing on the multi-modal data to obtain the preprocessed multi-modal data; the data encoding and alignment module is configured to perform the data encoding on the preprocessed multi-modal data to obtain the feature vector, and align the preprocessed multi-modal data using the cross-modal token alignment technology to obtain the feature representation; the model training and optimization module is configured to train the neural network model using the feature vector and the feature representation to obtain the trained large model, and perform the pruning operation, the distillation operation, and the quantization operation on the trained large model to generate the small model; and the model deployment and control module is configured to deploy the small model to the edge computing device, wherein the edge computing device acquires the text data of the current instruction in real time and performs inference on the text data to generate the robot action planning, and perform the real-time control of the robot manipulation actions using the robot action planning and the feedback signals from the plurality of sensors.

### BRIEF DESCRIPTION OF THE DRAWINGS

FIG. 1 is an exemplary flowchart of a real-time control method for robot manipulation actions based on collaboration between a large model and a small model according to some embodiments of the present disclosure.

FIG. 2 is an exemplary flowchart of an overall process logic for testing real-time motion planning of a robotic arm and real-time grasping capability of a robotic hand according to some embodiments of the present disclosure.

FIG. 3 is a schematic diagram illustrating a principle of collaboration between a large model and a small model according to some embodiments of the present disclosure.

FIG. 4 is a schematic diagram illustrating a model implementation process according to some embodiments of the present disclosure.

FIG. 5 is an exemplary flowchart of a model quantization implementation way according to some embodiments of the present disclosure.

FIG. 6 is an exemplary flowchart of adjustment of grasping force according to some embodiments of the present disclosure.

### DETAILED DESCRIPTION

The technical solutions in the embodiments of the present disclosure will be described clearly and completely below with reference to the accompanying drawings in the embodiments of the present disclosure. It is apparent that the described embodiments are only part of the embodiments of the present disclosure, not all embodiments. Based on the embodiments in the present disclosure, all other embodiments obtained by a person of ordinary skill in the art without creative efforts shall fall within the protection scope of the present disclosure.

In some embodiments, a real-time control method for robot manipulation actions based on collaboration between a large model and a small model can perform visual sensing, tactile feedback, torque monitoring, pose perception, multi-modal large model, and fast inference based on edge computing.

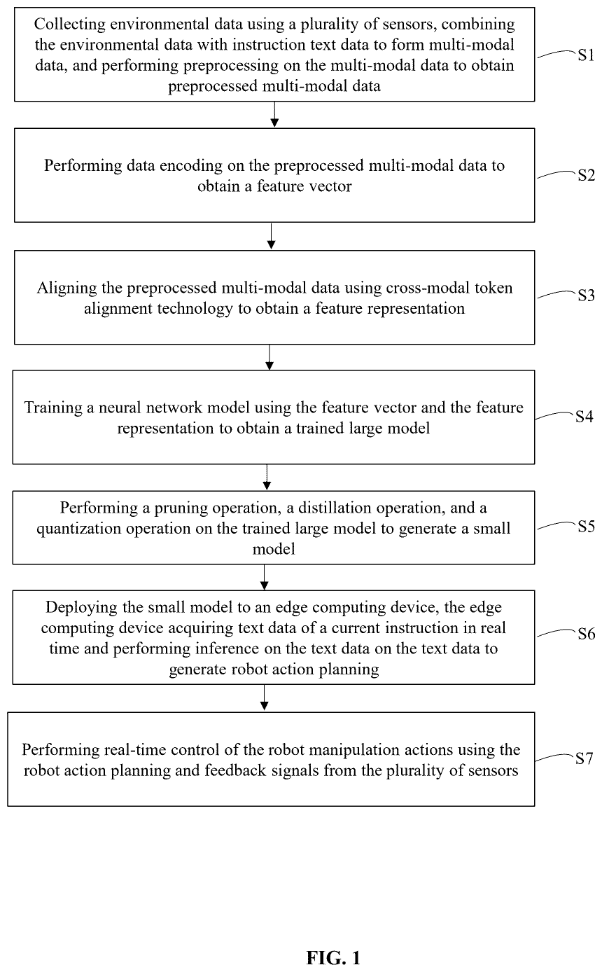

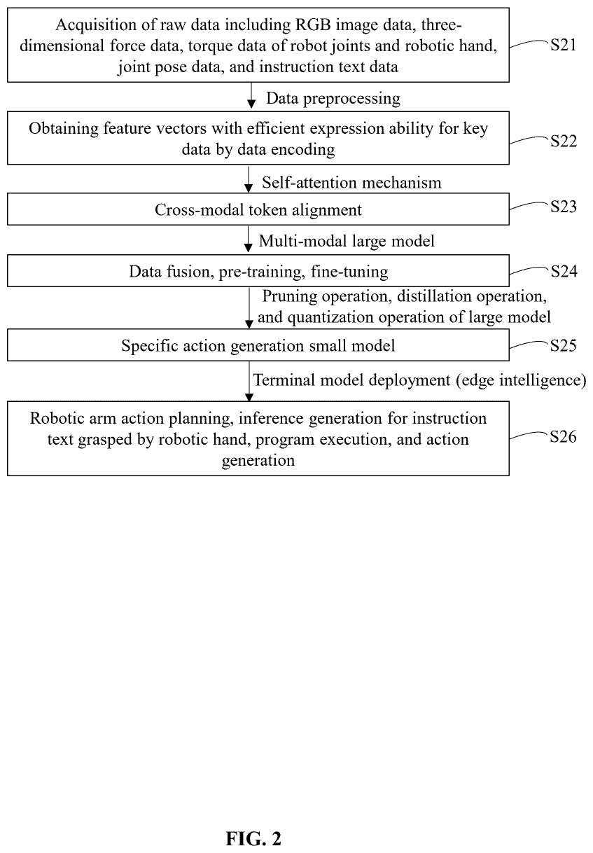

FIG. 1 is an exemplary flowchart of a real-time control method for robot manipulation actions based on collaboration between a large model and a small model according to some embodiments of the present disclosure. FIG. 2 is an exemplary flowchart of an overall process logic for testing real-time motion planning of a robotic arm and real-time grasping capability of a robotic hand according to some embodiments of the present disclosure. As shown in FIG. 1, the process is executed by a processor in a real-time control system for robot manipulation actions based on collaboration between a large model and a small model (hereinafter referred to as the system), and includes the following steps.

Here, the large model refers to a neural network model with a large parameter scale, which is obtained through training on massive data and capable of handling and understanding complex tasks. For example, the large model is a pre-trained language model based on a Transformer architecture. The small model refers to a neural network model derived from the large model through model compression techniques, with a small parameter scale and faster inference speed. For example, the small model is a specialized model suitable for deployment on edge devices, which is obtained by performing pruning, distillation, and quantization operations on the large model.
Step S1, collecting environmental data using a plurality of sensors, combining the environmental data with instruction text data to form multi-modal data, and performing preprocessing on the multi-modal data to obtain preprocessed multi-modal data.

The sensor is a device used for collecting environment data of the robot or information about the robot state. In some embodiments, the sensors include a visual sensor, a tactile sensor, a torque sensor, an inertial measurement unit, etc. For more information about the sensors, please refer to the related description below.

The environmental data is data describing the environment in which the robot is located, which is obtained by the sensors from the environment surrounding the robot. For example, the environmental data includes information such as images, object positions, force conditions, and the robot posture.

In some embodiments, the environmental data includes image data, positioning data, tactile feedback data, torque data, and pose data. For more information about the environmental data, please refer to the related description below.

The instruction text data refers to an operation instruction represented in text form, used to guide the robot to perform a specific task, such as grabbing or moving an object. For example, the instruction text data is “grab the red cube”.

In some embodiments, the instruction text data is determined by obtaining user input.

The multi-modal data refers to a dataset composed of a plurality of types of data. In some embodiments, the multi-modal data is composed of the environmental data and the instruction text data.

In some embodiments, the processor collects image data of surrounding environment and positioning data of an object to be grabbed using a visual sensor combined with a deep convolutional network, collects tactile feedback data of a robotic hand using the tactile sensor, collects torque data of joints of a robotic arm using a torque sensor, and collects pose data of the robotic arm using the torque sensor combined with an inertial measurement unit.

The visual sensor is a device for collecting image data of the surrounding environment, e.g., a depth camera, a Red Green Blue (RGB) camera, or a Light Detection and Ranging (LiDAR).

In some embodiments, the visual sensor includes at least one of a depth camera, an RGB camera, a LiDAR, or a stereo vision camera, configured to simultaneously obtain a two-dimensional image, depth information, and position information in three-dimensional space of a target object (e.g., the object to be grabbed).

The image data of the surrounding environment refers to images (e.g., photos) of the environment surrounding the robot. The image data of the surrounding environment is collected by the visual sensor.

The object to be grabbed refers to a target entity that needs to be recognized, positioned, and grasped by the robotic hand in a robot manipulation task. In some embodiments, the object to be grabbed is determined by obtaining user input.

The positioning data refers to data describing features of the object to be grabbed in three-dimensional space. In some embodiments, the positioning data includes a geometric boundary, surface features, and a spatial position of the object to be grabbed. In some embodiments, the spatial position further includes a three-dimensional position of the object to be grabbed.

In some embodiments, the positioning data of the object to be grabbed further includes a volume of the object to be grabbed and a relative motion trajectory of the object to be grabbed.

The deep convolutional network is a deep learning model for processing image data. For example, a deep neural network (DNN) used in semantic segmentation technology, or the like.

In some embodiments, the deep neural network (DNN) used in semantic segmentation technology performs pixel-level target segmentation and classification on input image data through a plurality of convolutional layers, generates edge contours, geometric information, and feature points of objects, and utilizes a deep learning model to semantically understand a scene, thereby further enhancing image feature recognition capability.

In some embodiments, a processor uses the visual sensor to collect image data of the surrounding environment, and uses a deep convolutional network (e.g., the deep neural network of semantic segmentation technology) to process the image data to obtain pixel-level features, the pixel-level features include features such as texture, color, and shape in the image data. For example, accurately identifying and locating pixel-level features of the object to be grabbed through the deep convolutional network. The positioning data of the object to be grabbed is obtained based on the pixel-level features. For example, based on features such as texture, color, and shape in the image data from the pixel-level features, a category and physical attributes of the object to be grabbed are determined, thereby further generating a geometric boundary, surface features, and spatial position of the object to be grabbed, i.e., the positioning data of the object to be grabbed.

In some embodiments, when accurately identifying and positioning pixel-level features of an object to be grabbed through a deep convolutional network, the processor uses formula (1) to process image data to obtain processed image I_{seg}, and the processed image I_{seg} includes pixel-level features. The formula (1) is expressed by:

$${I}_{seg} = Segmentation \cdot {I}_{raw} . \qquad ( 1 )$$

In formula (1), I_{seg} denotes the processed image, I_{raw} denotes image data collected by the visual sensor, and Segmentation denotes a semantic segmentation operation.

In some embodiments, the processor obtains positioning data of an object to be grabbed based on pixel-level features through formula (2):

$${P}_{object} = f ( {I}_{seg} ) . \qquad ( 2 )$$

In formula (2), f denotes a deep learning-based feature extraction model, and P_{object} denotes positioning data of the object to be grabbed. In some embodiments, the processor also obtains features such as a geometric boundary B and surface features S of the object to be grabbed based on pixel-level features through formula (2).

In some embodiments, the processor performs three-dimensional positioning and motion trajectory acquisition on an object to be grabbed, thereby obtaining positioning data of the object to be grabbed. That is, the processor combines visual sensors such as a depth camera, an RGB camera, or a LiDAR to obtain a three-dimensional position, a volume, and a relative motion trajectory of the object to be grabbed.

The tactile sensor is a sensor installed on a contact surface of a robotic hand, which is configured to perceive mechanical information when in contact with an object.

The tactile feedback data of the robotic hand provides electric signal data of an interaction force between the robotic hand and the object. For example, a magnitude of an electric current. Tactile feedback data of the robotic hand is obtained through real-time monitoring by the tactile sensor.

The torque sensor is a sensor installed at a joint of a robotic arm, which is configured to measure torque (moment) experienced when the joint rotates.

The inertial measurement unit (IMU) is a device that, together with the torque sensor, collects pose data of a robotic arm, e.g., an accelerometer and a gyroscope, etc.

The pose data of the robotic arm is data describing a position and an attitude of the robotic arm in three-dimensional space. For example, the pose data of the robotic arm includes torque and pose (e.g., a pitch angle of a joint) of joints of the robotic arm.

In some embodiments, the processor uses the torque sensor to monitor torque data of joints of a robotic arm in real time through formula (3), which is expressed by:

$$τ = Torque ( θ , Δθ ) = \int T ( t ) dt , \qquad ( 3 )$$

In formula (3), t denotes torque of joints of the robotic arm, θ is an angle of a joint, Δθ denotes an angular change of the joint, and T(t) denotes torque output by the torque sensor.

In some embodiments, the processor determines a pose matrix of a robotic arm through formula (4) based on pose data obtained by an inertial measurement unit, and the formula (4) is expressed by:

$$R = {R}_{IMU} ( θ ) . \qquad ( 4 )$$

In formula (4), R denotes the pose matrix of the robotic arm, θ denotes an angle of a joint, and R_{IMU} represents pose data provided by the inertial measurement unit.

In some embodiments, the tactile sensor is a sensor integrated in the finger portion of a robotic hand, such as a magnetic sensor, a vision-tactile sensor, etc., which is configured to perceive real-time force changes applied during a grasping process, and further adjust a grasping force in real time by monitoring tactile feedback data of the robotic hand (e.g., a magnitude of an electric current in an electric signal), ensuring that the robot can flexibly adapt to object shape, stiffness, and surface characteristics.

The preprocessing refers to an operation of performing preliminary processing on raw data to improve data quality or unify data format. For example, preprocessing includes data denoising, data normalization, data completion, data augmentation, etc. In some embodiments, the processor obtains standardized and high-quality multi-modal data (i.e., the preprocessed multi-modal data) by preprocessing multi-modal data.

In some embodiments, when performing multi-modal data preprocessing and fusion, the processor preprocesses multi-modal data from the visual sensor, the tactile sensor, the torque sensor, and the pose data, the preprocessing including steps such as denoising, data normalization, feature selection, and data augmentation, to improve quality and stability of the data. The preprocessing removes environmental noise, reduces data fluctuations, improves accuracy and stability of data processing, and ensures consistency of data from different sources, facilitating subsequent fusion and analysis.

In some embodiments, the processor preprocesses multi-modal data, and the preprocessing includes at least one of data denoising, data normalization, data completion, or data augmentation.

In some embodiments, the processor preprocesses multi-modal data based on formula (5), which is expressed by:

$${D}_{nor} = ( {D}_{raw} - μ ) / σ . \qquad ( 5 )$$

In formula (5), Draw denotes raw data (i.e., multi-modal data before preprocessing), u denotes a mean of the raw data, σ denotes a standard deviation of the raw data, and Dₙₒᵣ denotes normalized data, i.e., the normalized multi-modal data.

In some embodiments of the present disclosure, by performing at least one of data denoising, data normalization, data completion, and data augmentation on the collected multi-modal data, data quality can be improved, ensuring stability and consistency of the data.
Step S2, performing data encoding on the preprocessed multi-modal data to obtain a feature vector.

The feature vector refers to a vector formed by performing data encoding on the preprocessed multi-modal data, which is used to represent core features of the multi-modal data.

The data encoding refers to a process of converting the preprocessed multi-modal data into a numerical feature vector. For example, based on data encoding, image data and text data are mapped to a feature vector.

In some embodiments, the data encoding is performed using a contrastive language-image pre-training (CLIP) model. The data encoding is performed using formula (6), which is expressed by:

$${V}_{enc} = Encoder ( {D}_{pro} ) . \qquad ( 6 )$$

In formula (6), V_{enc} denotes the feature vector after data encoding, and Dₚᵣₒ denotes the preprocessed multi-modal data.

In some embodiments of the present disclosure, by selecting the CLIP model for data encoding, semantic consistency and generalization of data encoding can be improved, providing an efficient and robust foundation for subsequent model training and real-time control.
Step S3, aligning the preprocessed multi-modal data using cross-modal token alignment technology to obtain a feature representation.

The feature representation refers to a feature obtained after processing by cross-modal token alignment technology, which is capable of uniformly representing semantics of the multi-modal data.

The cross-modal token alignment technology refers to a technology for unifying feature vectors of different modalities to generate a unified feature representation.

In some embodiments, when a processor performs data encoding and cross-modal token alignment technology, the processor encodes the preprocessed multi-modal data, fuses multi-source data such as instruction text data, image data, torque data, and pose data, and generates a feature vector. Using the cross-modal token alignment technology, the instruction text data and the environmental data are effectively connected to generate a unified feature representation, facilitating unified task modeling and inference, and ensuring effective interaction and collaborative processing between different modal data.

In some embodiments, the cross-modal token alignment technology employs a deep learning architecture for joint training to fuse the multi-modal data. For example, cross-modal token alignment technology employs the Transformer architecture for joint training, aligning the text “red” with a red region in an image in a feature space. An alignment formula of the cross-modal token alignment technology is formula (7), which is expressed by:

$${V}_{ali} = Align ( {V}_{text} , {V}_{image} , {V}_{force} , {V}_{pose} ) . \qquad ( 7 )$$

In formula (7), Vₐₗᵢ denotes an aligned feature representation, Vₜₑₓₜ denotes a text feature vector, V_{image} denotes an image feature vector, V_{force} denotes a force sensing data feature vector, Vₚₒₛₑ denotes a pose data feature vector of joints of the robotic arm, and Align denotes a fusion function based on the Transformer architecture.

The Transformer architecture refers to a deep learning architecture based on a self-attention mechanism. In some embodiments, the processor, in cross-modal token alignment technology, uses a fusion function based on the Transformer architecture to fuse multi-modal data.

In some embodiments, the processor processes text data, image data, torque data, and pose data of joints of the robotic arm using the CLIP model to obtain a text feature vector, an image feature vector, a force sensing data feature vector, and a pose data feature vector of joints of the robotic arm.

In some embodiments of the present disclosure, by using the Transformer architecture in cross-modal token alignment technology, multi-modal data can be dynamically fused to generate an aligned feature representation Vₐₗᵢ, thereby improving accuracy and generalization capability of robot action planning.

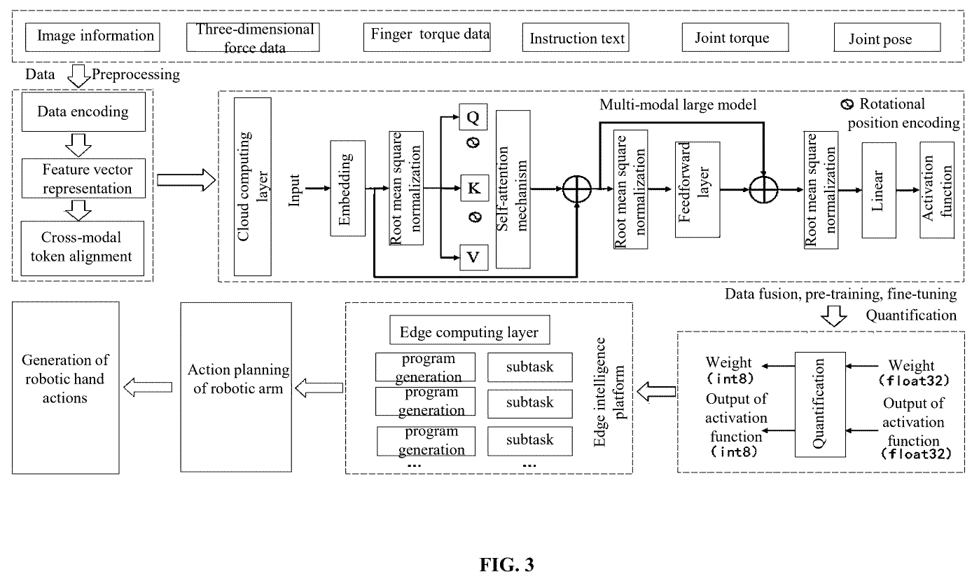

FIG. 3 is a schematic diagram illustrating a principle of collaboration between a large model and a small model according to some embodiments of the present disclosure.

In some embodiments, the large model includes a large language model meta AI (LLaMA). As shown in FIG. 3, during a pre-training phase, the large model uses a strategy similar to autoregressive language modeling to learn contextual information. A core objective of learning contextual information is to predict a next word based on previous words. Given an input text sequence x₁, x₂ . . . xₜ, the large model predicts a conditional probability of each word xₜ according to formula (8), which is expressed by:

$$P ( {x}_{t} \vert {x}_{1} , {x}_{2} , ... , {x}_{t - 1} ) = Softmax ( W \cdot {h}_{t} + b ) . \qquad ( 8 )$$

In formula (8), P(xₜ|x₁, x₂, . . . , xₜ₋₁) denotes a conditional probability of each word xₜ hₜ denotes a hidden state of the large model at time step t, W denotes a weight matrix for outputting word probabilities, b denotes a bias term, and Softmax denotes a function for converting an output of the large model into a probability distribution.

An objective of model training is to maximize a likelihood function of training data, which is achieved in practice by minimizing a cross-entropy loss function, which is expressed by:

$${LM}_{} = - {\sum }_{t = 1}^{T} log P ( {x}_{t} \vert {x}_{1} , {x}_{2} , ... , {x}_{t - 1} ) . \qquad ( 9 )$$

In formula (9), [symbol] _{LM} denotes the minimized cross-entropy loss function.

By minimizing the cross-entropy loss function, the large model gradually learns how to predict a next word given contextual information.

In some embodiments, a key component in the Transformer architecture adopted by the large model is a self-attention mechanism. For each position in an input text sequence, the large model calculates a correlation between the position and other positions through a self-attention mechanism corresponding to formula (10), which is expressed by:

$$Attention ( Q , K , V ) = Softmax ( {QK}^{T} / \sqrt{{d}_{k}} ) V . \qquad ( 10 )$$

In formula (10), Q, K, and V are matrices for query, key, and value, respectively, and dₖ is a dimension of a key vector.

The self-attention mechanism calculates a similarity (i.e., correlation) between each position and keys of other positions and weights matrixes of values to obtain a weighted sum for each position. The self-attention mechanism allows the large model to consider all other words in a context when generating each word, thereby obtaining richer semantic information.

In some embodiments, the processor fine-tunes the pre-trained large model to adapt the large model to a specific task, such as text classification, sentiment analysis, etc. During the fine-tuning process, the processor optimizes the large model by adjusting a task-specific loss function, as shown in formula (11), which is expressed by:

$${task}_{} = {\sum }_{t = 1}^{T} log P ( {y}_{i} \vert {x}_{i} ) . \qquad ( 11 )$$

In formula (11), [symbol] ₜₐₛₖ denotes an optimized task-specific loss function, yᵢ denotes a label corresponding to an i-th input text sequence, xᵢ denotes the i-th input text sequence, and P(yᵢ|xᵢ) denotes a conditional probability of a predicted label for the i-th input text sequence.
Step S4, training a neural network model using the feature vector and the feature representation to obtain a trained large model.

The neural network model refers to a model for processing the feature vector and the feature representation. In some embodiments, the neural network model is a large-scale multi-modal pre-trained neural network model stored in a cloud.

The trained large model refers to a high-precision, high-performance model obtained by training the neural network model using the feature vector and the feature representation.

The large model (i.e., a large language model) has achieved significant results in fields such as image recognition, speech processing, and natural language processing. Through learning from massive data, the large model is capable of acquiring a powerful understanding of complex tasks. However, in practical applications, the large model has disadvantages such as high computational resource consumption and slow inference speed, making it difficult to meet real-time and edge computing requirements.

In some embodiments, the processor inputs the fused data (i.e., the feature vector and the feature representation) into a neural network model (e.g., a large-scale multi-modal pre-trained neural network model in the cloud). Through steps such as joint learning, pre-training, and fine-tuning, a trained large model is obtained. The trained large model is capable of generating robot action planning based on a scene environment, a grasping task, and object characteristics.

In some embodiments, during the training of the neural network model using the feature vector and the feature representation, a data parallelism strategy and a model parallelism strategy are adopted, including: dividing training data into a plurality of batches; performing computation for each batch of the plurality of batches on a different graphics processing unit (GPU) to obtain updated parameters corresponding to each batch; and synchronizing the updated parameters corresponding to each batch via communication.

In the data parallelism strategy, the training data is split into a plurality of batches, and the plurality of batches are simultaneously assigned to a plurality of computing units (e.g., GPUs) for parallel computation.

In the model parallelism strategy, when the model scale is too large to fit entirely into the memory of a single computing unit, different parts of a single model (e.g., different neural network layers) are distributed across the plurality of computing units.

In some embodiments, the processor splits the training data into a plurality of batches by a preset batch size. The preset batch size is preset based on empirical knowledge.

The updated parameters corresponding to each batch refer to adjustment amounts (i.e., gradients) of model parameters (e.g., weights and biases) calculated by each computing unit based on a data batch assigned to the computing unit after processing the data batch.

In some embodiments, in data parallelism, the training data is split into a plurality of batches. Each batch is computed on a different GPU according to formula (12), and the updated parameters corresponding to each batch are obtained respectively. Formula (12) is expressed by:

$${θ}_{i}^{( t + 1 )} = {θ}_{i}^{( t )} - γ ∇ {i}_{} . \qquad ( 12 )$$

In formula (12),

$${θ}_{i}^{( t )}$$

denotes the model parameter for the i-th computing unit, γ denotes a learning rate, ∇ [symbol] ᵢ denotes the gradient calculated on the i-th computing unit, and t and t+1 denote the t-th batch and the (t+1)-th batch, respectively.

In some embodiments, after all computing units complete the calculation of updated parameters for their respective batches of training data, the updated parameters from all computing units are aggregated via a communication network to obtain a unified updated parameter. The unified updated parameter is then synchronized to all computing units. For example, an average of the gradients of all updated parameters is calculated, and then the average of the gradients is used to update the model parameters on each computing unit.

In some embodiments of the present disclosure, by splitting the training data into a plurality of batches and performing computation for each batch on a different GPU, the burden on computing units can be reduced and the computation rate can be accelerated. By synchronizing the updated parameters corresponding to each batch via communication, the consistency of the large model can be maintained.
Step S5, performing a pruning operation, a distillation operation, and a quantization operation on the trained large model to generate a small model.

The small model is a lightweight model corresponding to the large model.

In some embodiments, the processor performs the pruning operation, the distillation operation, and the quantization operation on the trained large model to generate the small model.

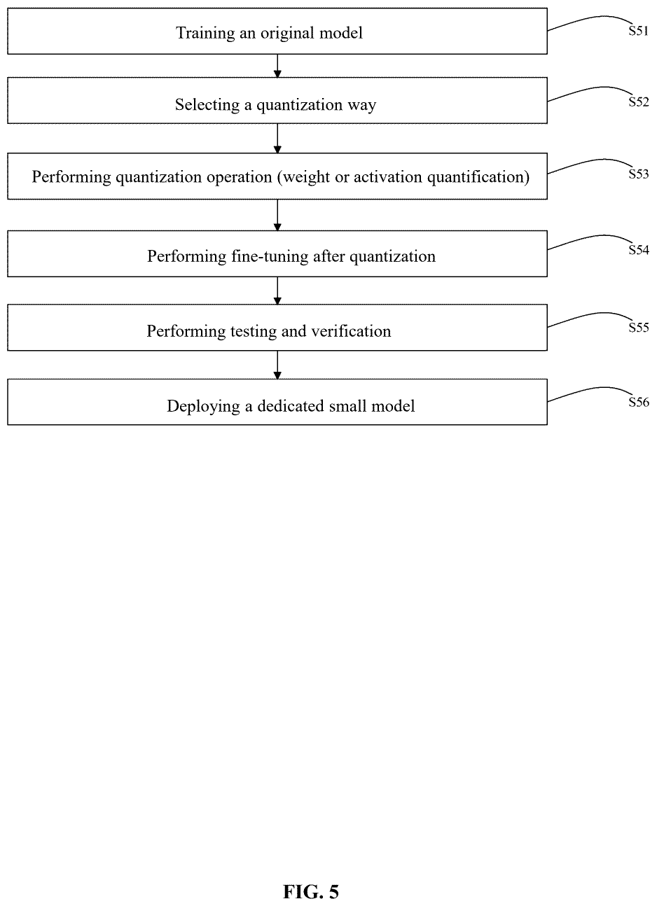

In some embodiments, the pruning operation is an operation for reducing model complexity by removing parameters from the trained large model. The distillation operation is an operation for transferring knowledge from the large model to the small model. FIG. 5 is an exemplary flowchart of a model quantization implementation way according to some embodiments of the present disclosure, including the following steps: S51, an original model (e.g., the large model) is trained; S52, a quantization way is selected; S53, the quantization operation (weight quantization or activation quantization) is performed; S54, fine-tuning after quantization is performed; S55, testing and verification is performed; S56, a dedicated small model is deployed. As shown in FIG. 5, the quantization operation is an operation for reducing computational overhead while ensuring the performance and accuracy of the model after compression.

In some embodiments, the pruning operation includes removing low-importance parameters. The distillation operation includes transferring knowledge from the trained large model to the small model. The quantization operation includes converting the trained large model from a high-precision floating point number representation to a low-precision representation.

The low-importance parameter refers to a parameter in the trained large model that has a weak influence on the final output result of the model. In some embodiments, the processor determines a parameter with a weight less than a weight threshold as a low-importance parameter. The weight is obtained from the large model, and the weight threshold is preset based on experience. For example, a parameter with a weight close to zero is determined as a low-importance parameter.

In some embodiments, the low-importance parameters are related to a task processing type and a task complexity of the edge computing device, and the task complexity is determined based on instruction granularity, a number of action types, a data volume of the multi-modal data, and environmental uncertainty.

The task processing type is a classification of tasks that the edge computing device needs to undertake. For example, the task processing type includes performing only path planning, performing grasping planning and force control coordination, or the like.

In some embodiments, the task processing type is determined by obtaining a user input.

The instruction granularity is a parameter for measuring a level of detail of the instruction text data. For more information about the instruction text data, please refer to the relevant content above.

In some embodiments, a greater number of instruction items in the instruction text data corresponds to a higher instruction granularity.

In some embodiments, the processor determines the instruction granularity by querying a first preset table based on the instruction text data. The first preset table records a correspondence between the instruction text data and the instruction granularity. The first preset table is preset based on experience.

The number of action types refers to a number of types of actions involved in the instruction text data. The action types include grasping, placing, obstacle avoidance, or the like.

In some embodiments, the processor inputs the instruction text data into a natural language model for recognition and classification to obtain the number of action types.

The environmental uncertainty is a parameter for evaluating dynamic changes in a task scene.

In some embodiments, the processor determines the environmental uncertainty by formula (13), and formula (13) is expressed by:

$${Q}_{uncertain} = f ( m ) . \qquad ( 13 )$$

In formula (13), m is a number of environmental interference factors, Q_{uncertain} is the environmental uncertainty, and f is a mapping function between the environmental uncertainty and the number of environmental interference factors. The number of environmental interference factors refers to a number of interference factors (e.g., lighting changes, cluttered background, object motion, object occlusion, or the like) present in the task scene.

In some embodiments, the number of environmental interference factors is obtained by recognizing image data acquired from the visual sensor by an image processing model.

In some embodiments, f is an exponential function.

The task complexity is a parameter for quantifying a difficulty level of a robot manipulation task.

In some embodiments, a higher instruction granularity corresponds to a higher task complexity.

In some embodiments, a higher number of action types corresponds to a higher task complexity.

In some embodiments, a higher environmental uncertainty corresponds to a higher task complexity.

In some embodiments, a larger data volume of multi-modal data corresponds to a higher task complexity. For more details regarding the multi-modal data, please refer to the above description.

In some embodiments, the processor first normalizes the instruction granularity, the number of action types, the data volume of the multi-modal data, and the environmental uncertainty. The processor then weights the normalized results and uses the weighted result as the task complexity. The weighting factors are preset based on experience.

The number of low-importance parameters refers to the number of parameters that need to be removed during a pruning operation.

In some embodiments, the processor first normalizes the task complexity to acquire a normalized task complexity. A higher task complexity corresponds to a higher type importance value and a larger number of low-importance parameters, i.e., fewer parameter details are required during the pruning operation. The type importance value is a parameter used to measure the importance level of a task processing type. The processor determines the type importance value by querying a second preset table based on the task processing type. The second preset table records a mapping relationship between task processing types and type importance values. The second preset table is preset based on experience.

In some embodiments, by associating the number of low-importance parameters with the task processing type and the task complexity of the edge computing device, the pruning operation can automatically adapt to the computational load according to requirements, achieving a dynamic balance between model lightweighting and performance preservation.

In some embodiments, the processor acquires a degree of influence of different model parameters in the trained large model on a key robot operation and determines the low-importance parameters based on the degree of influence.

The key robot operation refers to an action operation that the robot is prone to execute incorrectly.

In some embodiments, the processor queries a third preset table based on the task processing type to acquire the key robot operation. The third preset table records a correspondence relationship between task processing types and key robot operations. The processor constructs the third preset table based on key robot operations and task processing types during historical execution of robot action planning.

The degree of influence is a parameter that measures the importance of a single parameter in the large model to an output result of the key robot operation.

In some embodiments, the processor acquires the degree of influence for each parameter through experiments. The experimental design is a controlled variable experiment. Specifically, a parameter to be verified is set as a variable while other parameters are kept constant. A change amplitude in confidence of the key operation in the model output result is observed under different parameter variation amplitudes of the parameter to be verified. A ratio of the change amplitude in confidence of the key operation to the parameter variation amplitude of the parameter to be verified is used as the degree of influence corresponding to that parameter to be verified. In some embodiments, the confidence of the key operation is acquired from an output of the model.

In some embodiments, the processor determines parameters whose corresponding degree of influence is less than an influence threshold as low-importance parameters, so that they can be removed based on the pruning operation. The influence threshold is preset based on experience.

In some embodiments of the present disclosure, by identifying the degree of influence of different parameters in the large model on key robot operations and further determining low-importance parameters, the pruning operation becomes more targeted and controllable. This significantly reduces model computational load and resource occupancy while ensuring the accuracy of key robot operations.

A high-precision floating point number representation refers to a format that uses a large number of bits (e.g., 32 bits) to represent a floating point number. A low-precision representation refers to a format that uses a small number of bits (e.g., an 8-bit integer) to represent a numerical value. In some embodiments, the high-precision floating point number (e.g., 32-bit single-precision floating point number, 64-bit double-precision floating point number, etc.) representation and the low-precision representation (e.g., 8-bit integer, etc.) are preset based on experience.

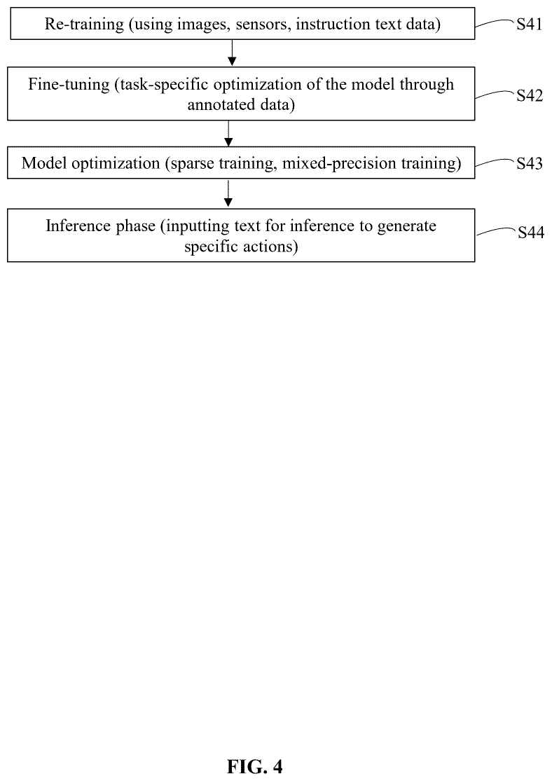

FIG. 4 is a schematic diagram illustrating a model implementation process according to some embodiments of the present disclosure, including the following steps: S41, pre-training (using images, sensors, instruction text data); S42, fine-tuning (task-specific optimization of the model through annotated data); S43, model optimization (sparse training, mixed-precision training); and S44, inference phase (inputting text for inference to generate specific actions). In some embodiments, as shown in FIG. 4, the quantization operation converts the high-precision floating point number representation into the low-precision (e.g., INT8) representation by formula (14). Formula (14) is expressed by:

$${W}_{quantized}^{′} = Quantize ( {W}^{′} ) . \qquad ( 14 )$$

In formula (14), W′ denotes a high-precision floating point weight parameter in the trained large model to be quantized, W′_{quantized} denotes a low-precision weight parameter obtained after quantization, Quantize denotes the quantization operation, such as a mapping function that implements conversion from a high-precision representation to a low-precision representation.

In some embodiments of the present disclosure, by removing low-importance parameters and transferring knowledge from the trained large model to the small model, it can reduce the storage and computational complexity of the large model. By converting the trained large model from the high-precision floating point number representation to the low-precision representation, it can reduce computational overhead and storage requirements.
Step S6, deploying the small model to an edge computing device, the edge computing device acquiring text data of a current instruction in real time and performing inference on the text data on the text data to generate robot action planning.

The edge computing device refers to a computing unit deployed at a robot operation site, such as a Field Programmable Gate Array (FPGA), a GPU, etc.

The text data of a current instruction refers to a specific operational command that are received in real time by the processor during operation and provided in the form of natural language text. For example, instruction text data described in natural language, environmental data, etc. In some embodiments, the text data of the current instruction is determined by obtaining user input.

The robot action planning refers to serialized instructions for controlling movement of a robotic arm and a robotic hand. In some embodiments, the robot action planning includes serialized instructions corresponding to manipulation actions (e.g., a grasping action) of the robotic arm or the robotic hand.

In some embodiments, the edge computing device acquires text data of a current instruction in real time and performs inference on the text data on the text data to generate robot action planning.

In some embodiments, the processor deploys the small model to the edge computing device. Hardware acceleration is utilized to achieve low-latency and high-efficiency text data inference. The process of text data inference is described by formula (15) and formula (15) is expressed by:

$$\hat{y} = Infer ( {M}_{small} , X ) . \qquad ( 15 )$$

In formula (15), ŷ denotes the robot action planning, X denotes the text data input to the small model, Mₛₘₐₗₗ denotes the small model, Infer denotes the inference process of the text data inference.

In some embodiments, the inference process Infer of the text data inference involves extracting features from the text data X input to the small model and computing a prediction result through forward propagation, i.e., the robot action planning before decoding. The forward propagation is described by formula (16) and formula (16) is expressed by:

$${h}_{t} = Transformer ( {X}_{t} , θ ) . \qquad ( 16 )$$

In formula (16), hₜ denotes the robot action planning before decoding, Xₜ denotes the text data input at time t, θ denotes a parameter weight of the small model, and Transformer denotes the Transformer model. The robot action planning ŷ is obtained based on the robot action planning hₜ before decoding through a decoding function (e.g., a softmax function).

In some embodiments, the processor controls the robotic arm and the robotic hand to generate a corresponding manipulation action based on the robot action planning obtained by the text data inference.

In some embodiments, the edge computing device includes a processor with hardware acceleration capability. For example, a processor with a built-in dedicated computing unit to enhance the speed of specific computing tasks.

In some embodiments of the present disclosure, by selecting the processor with hardware acceleration capability and deploying the small model to the edge computing device, it can achieve low-latency and high-efficiency data inference through hardware acceleration.
Step S7, performing real-time control of the robot manipulation actions using the robot action planning and feedback signals from the plurality of sensors.

The feedback signals refer to electric signals that are monitored in real time and returned by sensors during execution of the robot manipulation actions, which are used to describe deviations between a current state of the processor and an expected target.

The manipulation action refers to a motion posture of a robotic arm or a robotic hand. For example, a grasping action.

In some embodiments, the processor queries a fourth preset table according to the robot action planning and the feedback signal to adjust the robot manipulation action. The fourth preset table is preset according to experience.

In some embodiments, when the robotic hand contacts an object to be grabbed, the tactile sensor converts a physical force change perceived during the grasping process into a weak current signal change. The process is a current detection technology.

The tactile sensor monitors in real time a force and a displacement applied by the robotic hand during a process of grasping the object to be grabbed and precisely adjusts the grasping force through the current detection technology. In some embodiments, the grasping force is adjusted in real time according to a signal fed back by the tactile sensor to ensure stability of grasping an object and avoid damage or slippage of the object. For example, when the current increases, indicating that the actually applied grasping force increases, the grasping force is reduced at this time to ensure stability of grasping the object.

In some embodiments, the processor controls real-time actions of a robotic arm and a robotic hand based on the robot action planning, adjusts the grasping force of the robot in real time based on the electric signal fed back by the tactile sensor; and optimizes a grasping path and manipulation actions of the robot in real time based on the torque data of the joints and the pose data of the robotic arm, combined with a motion control algorithm.

The grasping force refers to a magnitude of an acting force applied to an object by the robotic hand when grasping the object.

In some embodiments, when the current in the tactile feedback data is less than an expected current, i.e., when the grasping force monitored in real time by the tactile sensor is less than an expected grasping force, the grasping force of the robot is increased. When the current in the tactile feedback data is greater than the expected current, i.e., when the grasping force monitored in real time by the tactile sensor is greater than the expected grasping force, the grasping force of the robot is reduced. The expected current is a current value of the tactile sensor under the expected grasping force. The expected current and the expected grasping force are set according to experience.

In some embodiments, the torque data of the joints and the pose data of the robotic arm are electric signals fed back by the torque sensor and the inertial measurement unit.

In some embodiments, the robot action planning further includes a grasping path.

The grasping path refers to a motion trajectory of the robotic arm or the robotic hand. For example, a trajectory of an end effector of the robotic arm moving from a starting position to a target grasping point.

The motion control algorithm refers to an algorithm used to calculate a motion trajectory and a control amount of each joint of the robot. In some embodiments, the processor combines the torque data of the joints and the pose data of the robotic arm with the motion control algorithm to optimize in real time the grasping path and the manipulation action of the robot. The motion control algorithm includes a proportional-integral-derivative (PID) control algorithm, a sliding mode control (SMC) algorithm, etc.

In some embodiments of the present disclosure, by combining the motion control algorithm to optimize in real time the grasping path and the manipulation action of the robot, it can improve stability and accuracy of the grasping action.

In some embodiments of the present disclosure, by preprocessing the collected multi-modal data, it can improve data quality and ensure stability and consistency of the data.

In some embodiments of the present disclosure, after completing training of the large model, a storage space and computational complexity of the model are reduced through the pruning operation, the distillation operation, and the quantization operation. By generating the small model, it can ensure efficient task execution and reduce computational overhead.

In some embodiments of the present disclosure, the processor can generate the robot action planning in real time to achieve efficient and precise robot operation. Through deep fusion of vision and touch, robot grasping efficiency and operation accuracy are improved, which is suitable for intelligent robots to perform grasping, operation, and task execution in complex environments.

One or more embodiments of the present disclosure provide a real-time control system for robot manipulation actions based on collaboration between a large model and a small model. The system includes a data acquisition and preprocessing module, a data encoding and alignment module, a model training and optimization module, and a model deployment and control module. The data acquisition and preprocessing module is configured to collect the environmental data using the plurality of sensors, combine the environmental data with the instruction text data to form the multi-modal data, and perform the preprocessing on the multi-modal data to obtain the preprocessed multi-modal data. The data encoding and alignment module is configured to perform the data encoding on the preprocessed multi-modal data to obtain the feature vector and align the preprocessed multi-modal data using the cross-modal token alignment technology to obtain the feature representation. The model training and optimization module is configured to train the neural network model using the feature vector and the feature representation to obtain the trained large model, and perform the pruning operation, the distillation operation, and the quantization operation on the trained large model to generate the small model. The model deployment and control module is configured to deploy the small model to the edge computing device, wherein the edge computing device acquires the text data of the current instruction in real time and performs inference on the text data to generate the robot action planning, and perform the real-time control of the robot manipulation actions using the robot action planning and the feedback signals from the plurality of sensors. In some embodiments, some or all of the aforementioned modules may be integrated into a processor to execute the method. More descriptions of the sensor, the environmental data, the instruction text data, the multi-modal data, the preprocessing, the feature vector, the feature representation, training of the large model, generating the robot action planning, and the feedback signals, refer to FIGS. 1-5 and their descriptions.

In some embodiments, the data acquisition and preprocessing module controls the robot to collect environmental information through the visual sensor and process an image through a semantic segmentation technology to obtain precise features of a target object. The data acquisition and preprocessing module uses depth camera data to obtain three-dimensional position information and a relative motion trajectory of the object. The data acquisition and preprocessing module obtains force and displacement information fed back in real time by the tactile sensor during the grasping process and ensures stability of the grasping process by adjusting a torque and a grasping force. The data acquisition and preprocessing module obtains a motion state of a robotic arm perceived by the torque sensor and an IMU to optimize a grasping path. After preprocessing, data encoding, and cross-modal token alignment are performed on the multi-modal data, the multi-modal data is input into the trained large model. An optimized robot operation strategy is generated through cloud training. The trained large model is converted into a dedicated small model for edge computing to achieve real-time action planning and execution.

In some embodiments, the data acquisition and preprocessing module performs visual information acquisition and processing, including: using a visual sensor (e.g., a depth camera, an RGB camera, or a LiDAR) to collect image information of the surrounding environment, and using a deep learning semantic segmentation technology to process the image to accurately identify and locate pixel-level features of the object to be grabbed. By obtaining information such as texture, color, and shape in the image, a category and physical properties of the object are determined, and a geometric boundary, surface features, and spatial position of the object are generated.

In some embodiments, the data acquisition and preprocessing module performs three-dimensional positioning and motion trajectory acquisition, including: combining sensors such as a depth camera, an RGB camera, or a LiDAR to obtain a three-dimensional position, a volume, and a relative motion trajectory of the object to be grabbed. This information provides precise object positioning in a highly dynamic environment, providing support for subsequent grasping tasks.

In some embodiments, the data acquisition and preprocessing module performs tactile perception and grasping force adjustment, including: based on the force and the displacement applied by a robotic hand monitored in real time by the tactile sensor during the grasping process, precisely adjusting the grasping force through a current detection technology, and adjusting the grasping force in real time according to the feedback signal from the tactile sensor to ensure stability of grasping the object and avoid damage or slippage of the object. The system is applied to perform torque and pose monitoring, using the torque sensor to monitor in real time angular torque changes of joints of the robotic arm, and combining the IMU to perceive in real time pose data of the robotic arm. Based on the angular torque changes of the joints of the robotic arm and the pose data of the robotic arm, a posture change of the robotic arm is calculated during motion, and the pose of the robotic arm is optimized through the motion control algorithm to precisely adjust an operation path and actions.

In some embodiments, the data acquisition and preprocessing module collects image information of the surrounding environment through the visual sensor and processes the image through a deep learning semantic segmentation technology to accurately identify and locate pixel-level features of the object to be grabbed, and generates a geometric boundary, surface features, and a spatial position of the object; and determine a category and physical properties of the object through information such as texture, color, and shape in the image.

In some embodiments, on the basis of the visual sensor, the data acquisition and preprocessing module combines sensors such as a depth camera, an RGB camera, or a LiDAR to obtain a three-dimensional position, a volume, and a relative motion trajectory of the object to be grabbed, thereby providing precise object positioning in a highly dynamic environment.

In some embodiments, the data acquisition and preprocessing module monitors in real time a force and a displacement applied by a robotic hand during the grasping process through the tactile sensor, precisely adjusts a grasping force through a current detection technology, and adjusts the grasping force in real time according to the signal fed back by the force sensor to ensure stability of grasping the object and avoid damage or slippage of the object.

In some embodiments, the data acquisition and preprocessing module uses the torque sensor to monitor in real time angular torque changes of joints of the robotic arm, and combines the IMU to perceive in real time pose data of the robotic arm, calculates a posture change during motion of the robotic arm, and achieves high-precision control of a pose of the robotic arm through the motion control algorithm to optimize the grasping path and the manipulation action.

In some embodiments, the visual sensor includes at least one of a depth camera, an RGB camera, a LiDAR, or a stereo vision camera, and is configured to simultaneously obtain a two-dimensional image, depth information, and position information in a three-dimensional space of a target object.

In some embodiments, the semantic segmentation technology uses a Convolutional Neural Network (CNN). A multi-layer convolutional network performs pixel-level target segmentation and classification on an input image to generate an edge contour, geometric information, and feature points of an object. A deep learning model is used to perform semantic understanding of a scene to further enhance image feature recognition capability.

In some embodiments, the tactile sensor is a magnetic sensor or the vision-tactile sensor integrated in a finger portion of the robotic hand and is configured to perceive a real-time force change applied during the grasping process. The grasping force is adjusted in real time through a current detection feedback signal to ensure that the robot can flexibly adapt to a shape, stiffness, and surface characteristics of an object.

In some embodiments, the torque sensor monitors in real time angular torque changes of joints of the robotic arm. The real-time pose data of the robotic arm is obtained through the IMU. The motion of the robotic arm is optimized and controlled by combining a dynamic model, thereby ensuring that the operation of the robot is precise and reliable.

In some embodiments, the data encoding and alignment module performs multi-modal data preprocessing and fusion, including: preprocessing multi-modal data from the visual sensor, the tactile sensor, the torque sensor, and pose data, the preprocessing including data denoising, data normalization, feature selection, and data augmentation, to improve quality and stability of the data. Through these preprocessing operations, environmental noise is removed, data fluctuations are reduced, and precision and stability of data processing are improved, ensuring that data from different sources has consistency and facilitating subsequent fusion and analysis.

In some embodiments, the data encoding and alignment module performs data encoding and cross-modal alignment, including: performing data encoding on the processed multi-modal data, and fusing multi-modal data such as instruction text, images, torque, and pose to generate an efficient feature vector. The cross-modal token alignment technology is utilized to effectively connect instruction text data and environmental data to generate a unified feature representation, facilitating unified task modeling and inference and ensuring effective interaction and collaborative processing between the multi-modal data.

In some embodiments, the model training and optimization module performs large model training and small model generation, including: inputting the fused multi-modal data into a large-scale multi-modal pre-trained neural network model in a cloud, and through steps such as joint learning, pre-training, and fine-tuning, generating a multi-modal task execution model that meets task requirements, i.e., the large model. The large model is capable of generating optimized robot manipulation strategies based on scene environment, grasping tasks, and object characteristics. When training the large model, data parallelism and model parallelism strategies are typically employed. In data parallelism, the training data is divided into a plurality of batches, each batch is computed on a different GPU, and updated parameters are synchronized via communication. After completing the training of the large model, a small dedicated model, i.e., the small model, is generated by performing a pruning operation, a distillation operation, and a quantization operation to reduce the storage space and computational complexity of the model, ensuring efficient task execution and reduced computational overhead. The distillation operation and the quantization operation include transferring knowledge from the large model to the small model. As shown in FIG. 5, computational overhead is reduced through quantization techniques to ensure performance and accuracy after model compression.

In some embodiments, the model deployment and control module performs edge computing and real-time inference, including: deploying the small model to an edge computing device, enabling low-latency and high-efficiency data inference through hardware acceleration. In combination with real-time acquired instruction text data, inference computation is performed to generate real-time action planning for the robotic arm and real-time grasping actions for the robotic hand. The edge computing device utilizes a processor with hardware acceleration capability (e.g., FPGA, GPU, etc.) to achieve low-latency and high-efficiency real-time inference computation, further accelerating the robotic arm action generation process, and collaborating with the cloud system through efficient communication protocols.

In some embodiments of the present disclosure, by applying the real-time control system for robot manipulation actions based on collaboration between a large model and a small model, it can overcome the deficiencies of existing robotic hands in grasping processes, such as lack of high-precision tactile perception, adaptive grasping capability, and real-time action planning capability. The system can efficiently process multi-modal data from a plurality of sensors and generate optimal operation strategies based on grasping tasks and object characteristics, thereby achieving precise grasping and manipulation in complex environments.

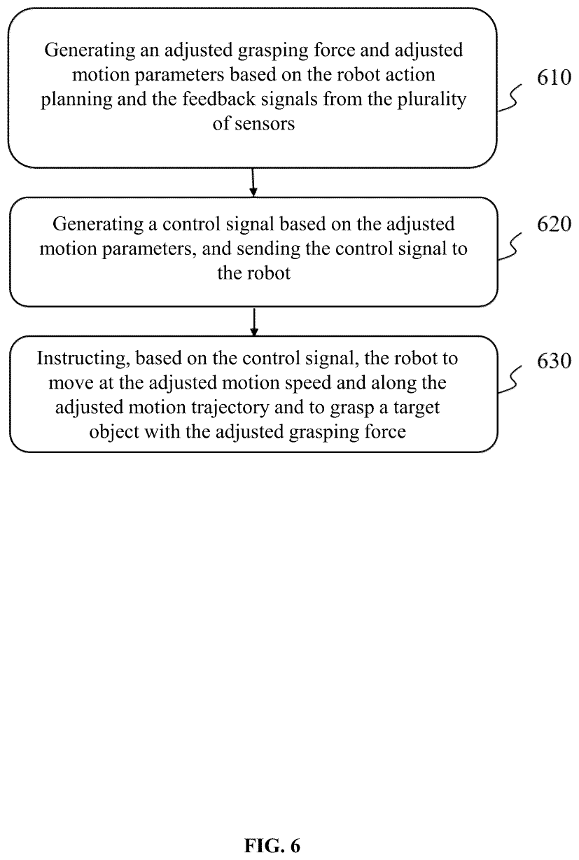

FIG. 6 is an exemplary flowchart of adjustment of grasping force according to some embodiments of the present disclosure.

As shown in FIG. 6, a process 600 includes the following steps. In some embodiments, the process 600 is executed by a processor.
Step 610, generating an adjusted grasping force and adjusted motion parameters based on the robot action planning and the feedback signals from the plurality of sensors.

For descriptions of the robot action planning, the feedback signals from the sensors, the grasping force, and the motion parameters, please refer to FIG. 1-FIG. 2 and the related descriptions.

In some embodiments, the adjusted motion parameters include an adjusted motion speed and an adjusted motion trajectory. The motion speed refers to a movement speed of the robot, and the motion trajectory refers to a movement path of the robot.

In some embodiments, the processor generates the adjusted grasping force and the adjusted motion parameters based on a difference between a predicted feedback signal from a corresponding sensor in the robot action planning and an actual feedback signal from the corresponding sensor when the robot action planning is actually executed. The actual feedback signal is the actual feedback signal from the plurality of sensors acquired in step S7 of FIG. 1. For more descriptions regarding generating the adjusted grasping force and the adjusted motion parameters based on the difference, please see the following.

The predicted feedback signal refers to a feedback signal predicted based on the robot action planning. In some embodiments, the processor obtains the predicted feedback signal by querying a second preset table based on the robot action planning.

The second preset table is a mapping table reflecting a relationship between robot action planning and predicted feedback signals. In some embodiments, the second preset table is determined based on empirical presets.
Step 620, generating a control signal based on the adjusted motion parameters, and sending the control signal to the robot.

The control signal refers to an instruction for controlling the robot to move. In some embodiments, the control signal is used to instruct the robot to move at the adjusted motion speed and along the adjusted motion trajectory, and to grasp a target object with the adjusted grasping force.
Step 630, instruct, based on the control signal, the robot to move at the adjusted motion speed and along the adjusted motion trajectory and to grasp a target object with the adjusted grasping force.

The target object refers to an object on which the robot performs an operation. For example, industrial parts, goods to be transported, or the like. In some embodiments, the processor identifies a position of the target object and controls the robot to perform operations on the target object, such as grasping based on the adjusted grasping force and transporting at the adjusted motion speed and along the adjusted motion trajectory.

In some embodiments of the present disclosure, by generating the adjusted grasping force and the adjusted motion parameters based on the robot action planning and the feedback signals from the plurality of sensors, it can achieve dynamic error compensation for robot manipulation, enhancing the manipulation precision of the robot.

In some embodiments, the processor determines a motion parameter and a grasping force of the robot at a future time point based on a sensor prediction signal corresponding to the future time point; and generates the adjusted grasping force and the adjusted motion parameters based on a difference between the feedback signals from the plurality of sensors at the future time point and the sensor prediction signal.

The future time point refers to one or more future execution time points extending backward from a current time point. In some embodiments, the future time point corresponds to execution time points of various manipulation actions in a future action sequence of the robot.

In some embodiments, the processor determines a number of future time points based on a task complexity and a number of target model parameters, wherein the target model parameters are model parameters for which a degree of influence on a key robot operation is greater than a preset threshold; and adjusts the number of the future time points based on an error rate and an action delay time of the robot during a current operation process. For more information on task complexity, please refer to the relevant description above.

The number of target model parameters refers to a number of parameters retained after performing the pruning operation on the large model, i.e., a number of parameters of the small model. For more descriptions of the small model, please refer to the above and the related descriptions.

In some embodiments, the higher task complexity and the smaller number of target model parameters correspond to the smaller number of future time points; the lower task complexity or the larger number of target model parameters correspond to the larger number of future time points.

The error rate refers to a ratio of a number of times of manipulation action deviations or failed manipulation actions occurring to a total number of manipulation actions during the execution of an operation process by the robot. In some embodiments, the processor determines the error rate based on feedback signals from sensors. For example, the processor obtains images of the robot during the execution of the operation process through a visual sensor, and obtains the number of times of manipulation action deviations or failed manipulation actions occurring and the total number of manipulation actions through an image processing model or manual annotation, thereby further using a ratio of the number of times of manipulation action deviations or failed manipulation actions occurring to the total number of manipulation actions as the error rate.

The action delay time refers to a time interval from when the edge computing device generates the robot action planning to when a robot execution mechanism (e.g., the robotic arm, the robotic hand) actually executes the manipulation action.

In some embodiments, the processor uses a timer to measure the time from generating the robot action planning to actually executing the manipulation action, thereby obtaining the action delay time.

In some embodiments, the lower the error rate, or the longer the action delay time, the larger the determined required number of future time points. For example, when the error rate is lower, it indicates that the sensor prediction signal does not closely match the sensor feedback signal. The processor appropriately increases the number of required future time points determined earlier to provide more frequent feedback and correction.

In some embodiments, the processor queries a fifth preset table based on the error rate and the action delay time to obtain the number of future time points. The fifth preset table records a correspondence relationship among the error rate, the action delay time, and the number of future time points, and the fifth preset table is preset based on experience.

In some embodiments of the present disclosure, the processor dynamically adjusts a number of future time points for predicting a future action sequence by combining task complexity with a number of target model parameters, thereby maintaining an adaptive balance between prediction depth and real-time correction capability. This improves execution stability and precision of the robot in different task scenarios.

In some embodiments, the processor determines a motion parameter and a grasping force of the robot at a future time point through a motion control algorithm based on a sensor prediction signal. For more details on how to determine the motion parameter and the grasping force of the robot at the future time point, refer to the related content above.

In some embodiments, the feedback signal of the sensors includes an electric signal fed back by the tactile sensor, an electric signal fed back by the torque sensor, an electric signal fed back by an inertial measurement unit, or the like.

In some embodiments, when an absolute value of a difference between the feedback signal of the sensors and the sensor prediction signal is not greater than a difference threshold, a current grasping force and a current motion parameter are determined as an adjusted grasping force and an adjusted motion parameter. When the absolute value of the difference between the feedback signal of the sensors and the sensor prediction signal is greater than the difference threshold, a grasping path and a manipulation action of the robot are optimized in real time based on the feedback signal of the sensors and in combination with the motion control algorithm, to obtain the adjusted grasping force and the adjusted motion parameters. For details on how to optimize the grasping path and the manipulation action of the robot in real time, refer to the description above and related descriptions.

In some embodiments of the present disclosure, the processor generates motion parameters and grasping forces for a plurality of future time points; and based on a difference between an actual sensor feedback signal and the sensor prediction signal at the future time points, corrects the motion parameters and the grasping forces in real time, which achieves a combination of predictive control and real-time correction, significantly reducing control delay and improving response speed.

In some embodiments, the processor predicts the sensor prediction signal corresponding to the future time point using a prediction model based on a future action sequence and a historical signal sequence. More descriptions of the sensor prediction signal corresponding to future time point, please refer to the previous description.

The future action sequence refers to a sequence formed by at least one future action in chronological order. The future action refers to an action that is about to be performed by the robot in a current task. In some embodiments, the processor determines the future action sequence based on robot action planning.

The historical signal sequence refers to a sequence formed by a plurality of historical signals in chronological order. The historical signal refers to feedback signals of a plurality of sensors collected by the robot at a plurality of historical time points before a current time point. In some embodiments, the processor determines the historical signal sequence based on historical data. For description of the feedback signal, refer to FIG. 1 and its description.

The prediction model refers to a model used to predict a sensor prediction signal corresponding to a future time point. In some embodiments, the prediction model is a machine learning model. For example, the prediction model is a neural network (NN), a convolutional neural network (CNN), or the like. In some embodiments, an input of the prediction model includes the future action sequence and the historical signal sequence, and an output of the prediction model includes the sensor prediction signal corresponding to the future time point.

In some embodiments, the processor trains and constructs the prediction model based on a large number of training samples and training labels corresponding to the training samples. In some embodiments, the processor obtains a training data set. The training data set includes a plurality of training samples and a training label corresponding to each training sample. The processor performs a plurality of rounds of iterations. At least one round of iterations includes: selecting one or more training samples from the training data set; inputting the one or more training samples with the training labels into an initial prediction model to obtain a result output by the initial prediction model; substituting the training labels of the one or more training samples and the result of the initial prediction model into a preset loss function; and iteratively updating parameters of the initial prediction model based on a value calculated by the loss function through gradient descent or another way. When a preset condition is met, model training is completed, and a trained prediction model is obtained. The preset condition is that the loss function converges, a number of iterations reaches a threshold, etc.

In some embodiments, the processor obtains a plurality of historical periods based on historical data and constructs a plurality of training samples and training labels corresponding to the training samples based on the plurality of historical periods. The processor randomly divides each historical period into two historical sub-periods. A historical signal sequence and a future action sequence corresponding to a historical sub-period that is earlier in chronological order (hereinafter referred to as a first period) are determined as a training sample corresponding to the historical period. A historical signal sequence corresponding to a historical sub-period that is later in chronological order (hereinafter referred to as a second period) is determined as a training label. The future action sequence corresponding to the first period refers to an actual action sequence within the second period.

In some embodiments of the present disclosure, by generating the sensor prediction signal corresponding to the future time point based on the future action sequence and the historical signal sequence, it is possible to perceive and estimate environmental changes in advance before the robot performs an action, thereby improving foresight of robot action planning and control stability.

The foregoing descriptions are merely specific embodiments of the present disclosure, but the protection scope of the present disclosure is not limited thereto. Any person skilled in the art can easily conceive of various equivalent modifications or substitutions within the technical scope disclosed in the present disclosure, and these modifications or substitutions shall fall within the protection scope of the present disclosure. Therefore, the protection scope of the present disclosure shall be subject to the protection scope of the claims.

What is claimed is:

1. A real-time control method for robot manipulation actions based on collaboration between a large model and a small model, comprising:
collecting environmental data using a plurality of sensors, combining the environmental data with instruction text data to form multi-modal data, and performing preprocessing on the multi-modal data to obtain preprocessed multi-modal data;
performing data encoding on the preprocessed multi-modal data to obtain a feature vector;
aligning the preprocessed multi-modal data using cross-modal token alignment technology to obtain a feature representation;
training a neural network model using the feature vector and the feature representation to obtain a trained large model;
performing a pruning operation, a distillation operation, and a quantization operation on the trained large model to generate a small model;
deploying the small model to an edge computing device, wherein the edge computing device acquires text data of a current instruction in real time and performs inference on the text data to generate robot action planning; and
performing real-time control of the robot manipulation actions using the robot action planning and feedback signals from the plurality of sensors.

2. The real-time control method according to claim 1, wherein the environmental data comprises image data, positioning data, tactile feedback data, torque data, and pose data; and
the collecting environmental data using the plurality of sensors comprises:
collecting image data of surrounding environment and positioning data of an object to be grabbed using a visual sensor combined with a deep convolutional network;
collecting tactile feedback data of a robotic hand using a tactile sensor;
collecting torque data of joints of a robotic arm using a torque sensor; and
collecting pose data of the robotic arm using the torque sensor combined with an inertial measurement unit.

3. The real-time control method according to claim 1, wherein the preprocessing comprises at least one of data denoising, data normalization, data completion, or data augmentation.

4. The real-time control method according to claim 1, wherein the data encoding is performed using a contrastive language-image pre-training (CLIP) model.

5. The real-time control method according to claim 1, wherein the cross-modal token alignment technology employs a deep learning architecture for joint training to fuse the multi-modal data, and an alignment formula of the cross-modal token alignment technology is expressed by:
$${V}_{ali} = Align ( {V}_{text} , {V}_{image} , {V}_{force} , {V}_{pose} ) ,$$
where Vₐₗᵢ denotes an aligned feature representation, Vₜₑₓₜ denotes a text feature vector, V_{image} denotes an image feature vector, V_{force} denotes a force sensing data feature vector, Vₚₒₛₑ denotes a pose data feature vector of the joints of the robotic arm, and Align denotes a fusion function based on a Transformer architecture.

6. The real-time control method according to claim 1, wherein during the training of the neural network model using the feature vector and the feature representation, a data parallelism strategy and a model parallelism strategy are adopted, comprising: dividing training data into a plurality of batches; performing computation for each batch of the plurality of batches on a different graphics processing unit (GPU) to obtain updated parameters corresponding to each batch; and synchronizing the updated parameters corresponding to each batch via communication.

7. The real-time control method according to claim 1, wherein the pruning operation comprises removing low-importance parameters; the distillation operation comprises transferring knowledge from the trained large model to the small model; and the quantization operation comprises converting the trained large model from a high-precision floating point number representation to a low-precision representation.

8. The real-time control method according to claim 7, wherein the low-importance parameters are related to a task processing type and a task complexity of the edge computing device, and the task complexity is determined based on instruction granularity, a number of action types, a data volume of the multi-modal data, and environmental uncertainty.

9. The real-time control method according to claim 8, further comprising:
acquiring a degree of influence of different model parameters in the trained large model on a key robot operation; and
determining the low-importance parameters based on the degree of influence.

10. The real-time control method according to claim 1, wherein the edge computing device comprises a processor with hardware acceleration capability.

11. The real-time control method according to claim 1, wherein the performing real-time control of the robot manipulation actions comprises:
controlling real-time actions of a robotic arm and a robotic hand based on the robot action planning, and adjusting a grasping force of the robot in real time based on an electric signal fed back by a tactile sensor; and
optimizing a grasping path and manipulation actions of the robot in real time based on electric signals fed back by a torque sensor and an inertial measurement unit, combined with a motion control algorithm.

12. The real-time control method according to claim 1, further comprising:
generating an adjusted grasping force and adjusted motion parameters based on the robot action planning and the feedback signals from the plurality of sensors, wherein the adjusted motion parameters comprise an adjusted motion speed and an adjusted motion trajectory;
generating a control signal based on the adjusted motion parameters, and sending the control signal to the robot; and
instructing, based on the control signal, the robot to move at the adjusted motion speed and along the adjusted motion trajectory and to grasp a target object with the adjusted grasping force.

13. The real-time control method according to claim 13, wherein the generating an adjusted grasping force and adjusted motion parameters based on the robot action planning and the feedback signals from the plurality of sensors comprises:
determining a motion parameter and a grasping force of the robot at a future time point based on a sensor prediction signal corresponding to the future time point; and
generating the adjusted grasping force and the adjusted motion parameters based on a difference between the feedback signals from the plurality of sensors at the future time point and the sensor prediction signal.

14. The real-time control method according to claim 13, further comprising:
determining a number of future time points based on a task complexity and a number of target model parameters, wherein the target model parameters are model parameters for which a degree of influence on a key robot operation is greater than a preset threshold; and
adjusting the number of the future time points based on an error rate and an action delay time of the robot during a current operation process.

15. The real-time control method according to claim 13, further comprising:
predicting the sensor prediction signal corresponding to the future time point using a prediction model based on a future action sequence and a historical signal sequence.

16. A real-time control system for robot manipulation actions based on collaboration between a large model and a small model, wherein the system operates by applying the real-time control method according to claim 1, and the system comprises a data acquisition and preprocessing module, a data encoding and alignment module, a model training and optimization module, and a model deployment and control module; wherein
the data acquisition and preprocessing module is configured to collect the environmental data using the plurality of sensors, combine the environmental data with the instruction text data to form the multi-modal data; and perform the preprocessing on the multi-modal data to obtain the preprocessed multi-modal data;
the data encoding and alignment module is configured to perform the data encoding on the preprocessed multi-modal data to obtain the feature vector, and align the preprocessed multi-modal data using the cross-modal token alignment technology to obtain the feature representation;
the model training and optimization module is configured to train the neural network model using the feature vector and the feature representation to obtain the trained large model, and perform the pruning operation, the distillation operation, and the quantization operation on the trained large model to generate the small model; and
the model deployment and control module is configured to deploy the small model to the edge computing device, wherein the edge computing device acquires the text data of the current instruction in real time and performs inference on the text data to generate the robot action planning, and perform the real-time control of the robot manipulation actions using the robot action planning and the feedback signals from the plurality of sensors.
